(19) United States
(12) Patent Application Publication
(10) Pub. No.: US 2026/0023206 A1
(43) Pub. Date: Jan. 22, 2026

(54) LIGHT GUIDE FOR A BACKLIGHT, BACKLIGHT AND DISPLAY DEVICE

(71) Applicant: Continental Automotive Technologies GmbH, Hannover (DE)

(72) Inventor: Christian JUNGE, Frankfurt am Main (DE)

(21) Appl. No.: 19/267,859

(22) Filed: Jul. 14, 2025

(30) Foreign Application Priority Data
Jul. 16, 2024 (DE) 10 2024 206 656.7

(51) Int. Cl. F21V 8/00

(52) U.S. Cl. CPC G02B 6/0028

(57) ABSTRACT

A light guide for a backlight unit, a backlight unit having such a light guide, and to a display device having such a backlight unit. The light guide has at least one light incoupling portion having an arrangement of total internal reflection collimators and a light guiding portion. The light guiding portion has a reflective inclined end face a top side, and an underside. The light guiding portion guides the light coming from the light incoupling portion within the light guiding portion to the inclined end face, and outcouples the light reflected by the inclined end face through the top side.

### BACKGROUND OF THE INVENTION

### 1. Field of the Invention

The present disclosure relates to a light guide for a backlight unit. The disclosure is furthermore directed to a backlight unit comprising such a light guide, and to a display device comprising such a backlight unit.

### 2. Description of Related Art

In modern motor vehicles, more and more information going far beyond the display of the vehicle state is being made available to the driver or other vehicle occupants. Therefore, conventional instrument clusters are increasingly being replaced by freely programmable digital displays. Such displays often use a transmissive display panel, e.g. a liquid crystal display panel, in combination with a backlight unit.

Nowadays, backlight units are mainly based on edge-lit light guides, into which the light from a plurality of light-emitting diodes (LEDs) is incoupled via a side surface of the light guide. The light propagates by total internal reflection in the light guide and is outcoupled again by specific outcoupling structures on the surface of the light guide or by a specific choice of the light guide geometry, such as e.g. a conical light guide. In order to modify and improve the efficiency, homogeneity and angular emission properties of the outcoupled light, additional components such as diffuser films, prism films, polarization films or specific coatings are often used.

U.S. Pat. No. 11,048,037 B2 discloses a backlight and a multiview display that use a light guide having an angle-preserving scattering function and a conical collimator. The angle-preserving scattering function is configured to scatter part of the guided light as emitted light out of the light guide. The conical collimator is configured to collimate the light provided by a light source as collimated light and to forward the collimated light as guided light to the light guide.

US 2007/0081360 A1 discloses a display backlight arrangement that provides an improved optical coupling between a solid-state light source and an optical display light guide. The assembly contains an optical coupler for coupling the solid-state light source and the optical light guide of the display. In addition, the optical coupler may contain a light mixing element for improved mixing of the multicolored or monochromatic light generated by the solid-state light source.

US 2017/0285242 A1 discloses a liquid crystal display device comprising a light source that emits light having a predefined color, a lens that concentrates the light emitted by the light source and causes the light to exit, a bandpass filter that transmits light in a specific wavelength band in the light exiting from the lens, and a light guide plate arranged on a rear side of a display panel. The light transmitted through the bandpass filter is incident on a lateral surface of the light guide plate.

The typical emission characteristic of an edge-lit backlight system has a wide angular distribution. While this property is advantageous for many applications where the display must be readable from a wide angular range, in some applications the light emitted by a display should be limited to a small angular range. Head-up displays or switchable privacy screens require very narrow and well-defined angular emission, for example. This narrow distribution cannot be achieved with current edge-lit light guides, so-called edge light configurations. Alternatively, direct-lit systems can be used to illuminate the display with a number of light sources and some collimation optics. This configuration allows narrow light distributions to be achieved. However, in order to achieve acceptable homogeneity, the space required for the illumination system is much larger in comparison with edge-lit systems.

### SUMMARY OF THE INVENTION

It is an object of one aspect of the present invention to provide a compact edge-lit backlight unit for a display device having a narrow angular light distribution, a high efficiency and a homogeneous illumination.

According to a first aspect, a light guide for a backlight unit has:
at least one light incoupling portion, wherein the at least one light incoupling portion has an arrangement of total internal reflection collimators; and
a light guiding portion wherein the light guiding portion has a reflective inclined end face, and wherein the light guiding portion has a top side and an underside, wherein the light guiding portion is configured such that it guides the light coming from the light incoupling portion within the light guiding portion to the inclined end face, and outcouples the light reflected by the inclined end face through the top side.

In order to generate a narrow light distribution with an edge-lit light guide, it is necessary to accurately control the angular distribution of the light propagating in the light guide. For this purpose, the light is collimated during incoupling. According to one aspect of the invention, an array of total internal reflection collimators (TIR) is used. In the simplest case, a plurality of total internal reflection collimators are arranged in a line next to one another, i.e. one-dimensionally. However, a two-dimensional, areal arrangement is also within the scope of the invention. Total internal reflection collimators are particularly advantageous since they are able to collect the light emitted by light-emitting diodes with high efficiency and to restrict the collected light to a small angular range.

According to one aspect of the invention, the collimated light firstly completely passes through the light guiding portion before it is reflected at the inclined end face. The long light path results in sufficient intermixing of the light from different light sources. Upon reflection at the inclined end face, the propagation angle in the light guiding portion is then additionally changed such that the light is still guided by total internal reflection, but at the same time impinges on the top side or the underside at a significantly steeper angle. According to one aspect of the invention, the inclined end face of the light guiding portion is embodied such that it reflects light which has passed through the light guiding portion once and reaches the end face. The light which reaches the end face is reflected and passes back through the light guiding portion in a changed direction, i.e. nonparallel to the direction of incidence. The end face is embodied such that the reflection causes a change in the propagation angle of the reflected light. Advantageously, the end face is inclined in relation to the direction of propagation of the light guided within the light guiding portion. In this way, it is only upon back-propagation that light is outcoupled. For example, suitably designed microstructures are provided for this purpose.

Advantageously, the top side and the underside of the light guiding portion are surfaces that are parallel to one another. This has the effect that when the almost parallel light rays first pass through the light guiding portion, they are almost always subjected to total internal reflection at the top side or underside.

It is likewise advantageous for the top side and underside to have a slight opening with respect to one another in the direction of the first light propagation from the light source to the opposite inclined end face. Here as well, total internal reflection is ensured at the top side or underside.

The array of total internal reflection collimators is connected to a light guiding portion. For efficient outcoupling of the light, the light guiding portion has a small thickness in order to increase the interaction of the light with the surfaces of the light guiding portion. This aspect according to the invention thus makes it possible to achieve narrow light distributions with very high efficiency and good light mixing. The light guide can be produced for example by injection molding or by combining a light guiding portion composed of glass with a light incoupling portion. The light guide can also consist completely of glass.

In one advantageous aspect, the underside of the light guiding portion has outcoupling structures, wherein the outcoupling structures have regions which are inclined relative to the underside of the light guiding portion and are configured such that they steer part of the light guided within the light guiding portion to the top side of the light guiding portion. A suitable choice of the geometry of the outcoupling structures in the light guiding portion results in the outcoupling of only a fraction of the widened angular distribution in the light guiding portion. The resulting angular distribution of the light at a display panel illuminated by the light guide is still very narrow as a result.

In one advantageous aspect, a length and a taper of the tapering light mixing section and also the inclination of the end face are embodied such that in conjunction with the outcoupling structures the light outcoupled from the light guiding section has a narrow angular distribution. Correct design of the conical light mixing portion, of the inclination of the end face and of the outcoupling structures enables the angular distribution of the light to be altered in a highly controlled manner.

In one advantageous aspect, a density of the outcoupling structures along a direction of propagation of the light guided within the light guiding portion is embodied such that the light outcoupled from the light guiding portion has a substantially constant brightness distribution over the entire length of the light guiding portion. Increasing the density of the outcoupling structures along the direction of propagation in the light guide makes it possible to achieve a substantially constant brightness distribution. The increased density of the outcoupling structures compensates for the reduction of the available quantity of light along the direction of propagation.

In one advantageous aspect, the light guide furthermore has a diffuser film arranged on or above the top side of the light guiding portion. Such a diffuser film can be used for example to further improve the homogeneity and modify the angular distribution of the light.

In one advantageous aspect, the light guide furthermore has a reflective coating arranged on the underside of the light guiding portion. In this way, light losses through the underside are greatly reduced, which increases the efficiency of the system.

In one advantageous aspect, the light guide furthermore has a reflective polarizer arranged on or above the top side of the light guiding portion. The embodiment without a conical light guiding portion, i.e. the embodiment in which the top side and underside of the light guiding portion are arranged parallel to one another, makes it possible to implement so-called polarization recycling. The reflective polarizer on or above the light guiding portion reflects light with a polarization state which would otherwise be absorbed by the display panel or some other component which follows the light guide and which is illuminated by means of the light guide. With the aid of a retardation layer or by means of birefringence, the polarization state of the reflected light upon a retroreflection at the underside of the light guiding portion can be converted into the usable polarization state. For this purpose, the light guide advantageously furthermore has a retardation layer arranged between the top side of the light guiding portion and the reflective polarizer. Alternatively, the light guiding portion can consist of a birefringent material. Both approaches increase the efficiency of the system.

In one advantageous aspect, the outcoupling structures have regions extending parallel to the underside of the light guiding portion. In this way, the outcoupling structures maximize the reflection and preserve the direction of the recycled light.

In one advantageous aspect, light incoupling portions and conical light mixing sections are arranged on two mutually adjacent sides of the light guiding portion, said sides usually being arranged at right angles to one another. This solution has the advantage that light can be incoupled into the light guiding portion from two different sides, which further improves the homogeneity of the light outcoupled from the light guiding portion.

Advantageously, a light guide according to one aspect of the invention is used in a backlight unit for a display device. The backlight unit furthermore has at least one arrangement of light sources configured such that they emit light in the direction of the total internal reflection collimators of the light guide.

Advantageously, a backlight unit according to one aspect of the invention is used in a display device, e.g. a display device for automotive applications. By way of example, the display device can be used in a head-up display or can be configured such that it provides a switchable data protection functionality. Of course, the use of the backlight unit is not restricted to these applications. The solutions described are suitable for all kinds of applications which require homogeneous planar illumination units having a controllable angular emission behavior.

In one aspect, the display device furthermore comprises a prism film configured such that it changes a direction of the illumination light emanating from the backlight unit. This is particularly useful if the viewing direction does not run perpendicular to a display panel of the display device, which may be the case if the display panel is inclined in order to avoid reflections of the sun. The prism film can be part of the backlight unit or a separate component of the display device.

### BRIEF DESCRIPTION OF THE DRAWINGS

Further features of the present invention are evident from the following description and the appended claims in conjunction with the drawings.

FIG. 1 shows a perspective view of a light guide according to the invention;

FIG. 2 shows a side view of the light guide from FIG. 1;

FIG. 3 shows a front view of a light incoupling portion from the light guide from FIG. 1;

FIG. 4 illustrates light paths and decoupling structures of the light guide from FIG. 1;

FIG. 5 shows a front view of a backlight unit;

FIG. 6 shows a front view of a backlight unit;

FIG. 7 shows a section through a display device including a backlight unit;

FIG. 8 shows a side view of the light guide;

FIG. 9 shows a total internal reflection collimator; and

FIG. 10 shows a further configuration of a light guide.

### DETAILED DESCRIPTION OF THE PRESENTLY PREFERRED EMBODIMENTS

The present description illustrates the principles of the present disclosure. A person skilled in the art is able to derive various arrangements which, although not expressly described or shown here, embody the principles of the disclosure.

All examples and conditional wording recited herein are intended for explanation purposes to aid the reader in understanding the principles of the disclosure and the concepts contributed by the inventor to furthering the art, and are to be construed as being without limitation to the specifically cited examples and conditions.

Moreover, all statements contained herein that recite principles, aspects and embodiments of the disclosure, as well as specific examples thereof, are intended to encompass both structural and functional equivalents thereof. Moreover, such equivalents are intended to encompass both currently known equivalents and equivalents developed in the future, i.e. all developed elements which fulfill the same function independently of their structure.

Thus, it is understood by those skilled in the art, for example, that the diagrams illustrated herein illustrate conceptual views that embody the principles of the disclosure.

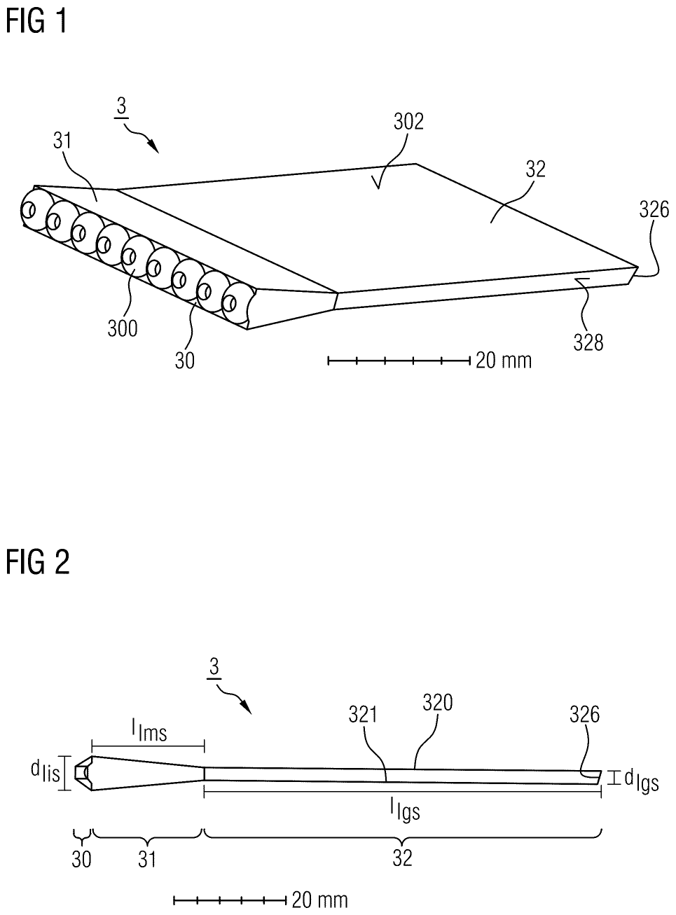

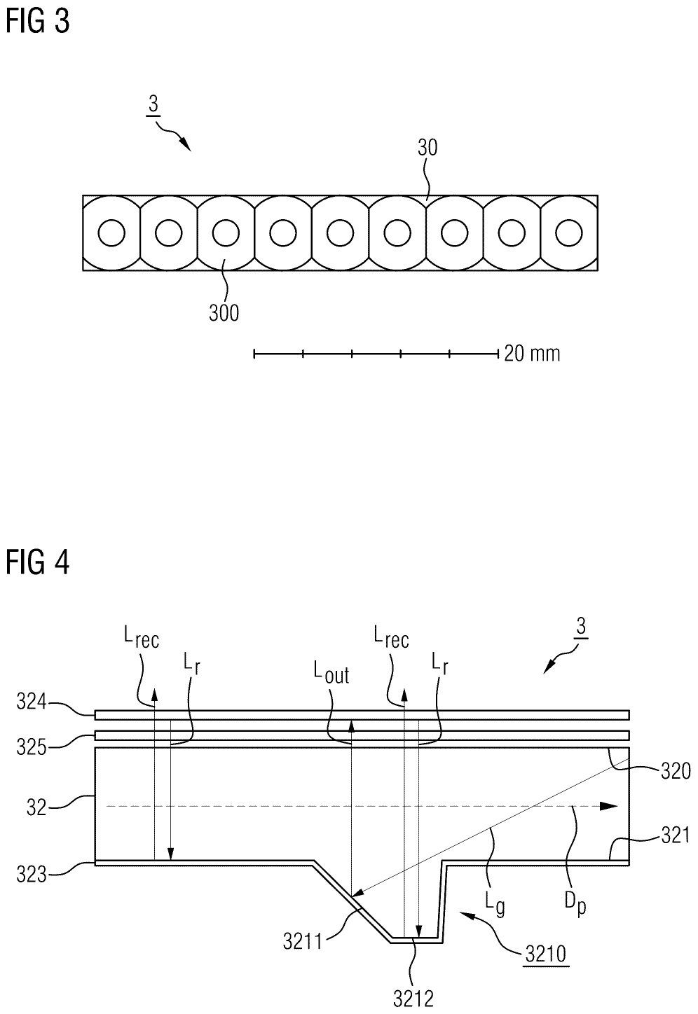

FIG. 1 shows a perspective view of a light guide 3 according to one aspect of the invention. A side view of the light guide 3 is illustrated in FIG. 2. The light guide 3 has a light incoupling portion 30, a conical light mixing portion 31 and a light guiding portion 32. The light incoupling portion 30 has a first thickness dₗᵢₛ and comprises an arrangement of total internal reflection collimators 300. A front view of the light incoupling portion 30 and the arrangement of the total internal reflection collimators 300 is illustrated in FIG. 3. The light guiding portion 32 has a length l_{lgs} and a second thickness d_{lgs}, which is smaller than the first thickness dₗᵢₛ. The conical light mixing portion 31 has a length lₗₘₛ and connects the light incoupling portion 30 and the light guiding portion 32. The light guiding portion 32 has an upper surface, the top side 320, and a lower surface, the underside 321, and is configured such that it outcouples light guided within the light guiding portion 32 through the upper surface 320. The light guiding portion 32 has a side surface 328. An end face 326 of the light guiding portion 32 is advantageously embodied so as to reflect light which is guided within the light guiding portion 32 and reaches the end face 326. The end face 326 is inclined, and so the light is not reflected on itself. While only one light incoupling portion 30 and one conical light mixing portion 31 are present in FIG. 1 and FIG. 2, light incoupling portions 30 and conical light mixing portions 31 can likewise be arranged on the side surface 328 of the light guiding portion 32.

FIG. 4 shows light paths and outcoupling structures 3210 of the light guide 3 from FIG. 1. The light L_{g} guided within the light guiding portion 32 of the light guide 3, upon first passing through the light guide 3, from left to right in the drawing, travels substantially parallel along a direction of propagation Dₚ. The outcoupling structures 3210 are arranged in a bottom surface 321 of the light guiding portion 32 of the light guide 3. Upon first passing through the light guide 3, the substantially parallel light does not interact or hardly interacts with the outcoupling structures 3210. In the exemplary embodiment, a reflective coating 323 is arranged on the underside 321 in order to reduce light losses through the underside 321. The outcoupling structures 3210 have regions 3211 which are inclined relative to the underside 321. The inclined regions 3211 are embodied such that they steer light L_{g} reflected by the inclined end face 326, said light being guided within the light guiding portion 32 in a manner inclined with respect to the direction of propagation Dₚ, to the top side 320 of the light guiding portion 32, where it at least partly leaves the light guiding portion 32 and thus forms outcoupled light Lₒᵤₜ.

The outcoupling structures 3210 furthermore have regions 3212 extending parallel to the top side 320. The light guide 3 is designed to realize so-called polarization recycling. A reflective polarizer 324 above the light guiding portion 32 reflects light Lᵣ with a polarization state which would otherwise be absorbed by a display field illuminated by means of the light guide 3. With the aid of a retardation layer 325, the polarization state of the reflected light Lᵣ upon a retroreflection at the underside 321 is converted into the usable polarization state. The resulting recycled light Lᵣₑₑ is then able to pass through the reflective polarizer 324. The retardation layer 325 is embodied for example as a retardation film, as a retardation sheet, or as a retardation coating.

The length and taper of the conical light mixing portion 31 of the light guide 3 and also the inclination angle of the inclined end face 326 are embodied such that in conjunction with the outcoupling structures 3210 the light outcoupled from the light guiding portion 32 has a narrow angular distribution. A density of the outcoupling structures 3210 along the direction of propagation Dₚ is advantageously embodied such that light Lₒᵤₜ outcoupled from the light guiding portion 32 has a substantially constant brightness distribution over the entire length of the light guiding portion 32.

FIG. 5 shows a front view of a backlight unit 2 in accordance with a first embodiment, which uses a light guide 3 according to the invention. The light incoupling portion 30 having the arrangement of total internal reflection collimators 300 is illustrated. The light sources 4 situated in front of the total internal reflection collimators 300 are likewise illustrated. A retardation film 325 and a reflective polarizer 324 for polarization recycling are arranged on the top side of the light guiding portion of the light guide 3. For the sake of better visualization, the retardation film 325 and the reflective polarizer 324 are illustrated as separate layers at a distance from one another. In practice, they can be stacked on the top side of the light guiding portion. Light which is outcoupled from the light guiding portion and travels through the reflective polarizer 324 serves as illumination light L₁. The illumination light L₁ passes through a diffuser film 322 arranged upstream of a display panel 8 in order to be illuminated. The diffuser film 322 can be used for example to further improve the homogeneity of the illumination light Lᵢ and modify the angular distribution of the light. The diffuser film 322 can additionally form a Fresnel lens. In this embodiment, the display panel 8 and the diffuser film 322 are arranged at an angle relative to the top side of the light guiding portion of the light guide 3. This is particularly useful if the backlight unit 2 is used in a head-up display. In order to suppress reflections of the sun into the eyebox of a head-up display, the display panel 8 is inclined such that incident light is deflected in the direction of a side wall of the head-up display. However, the light from a picture generating unit of the head-up display needs to be emitted along the viewing direction. Therefore, it leaves the display panel 8 at an angle, rather than vertically.

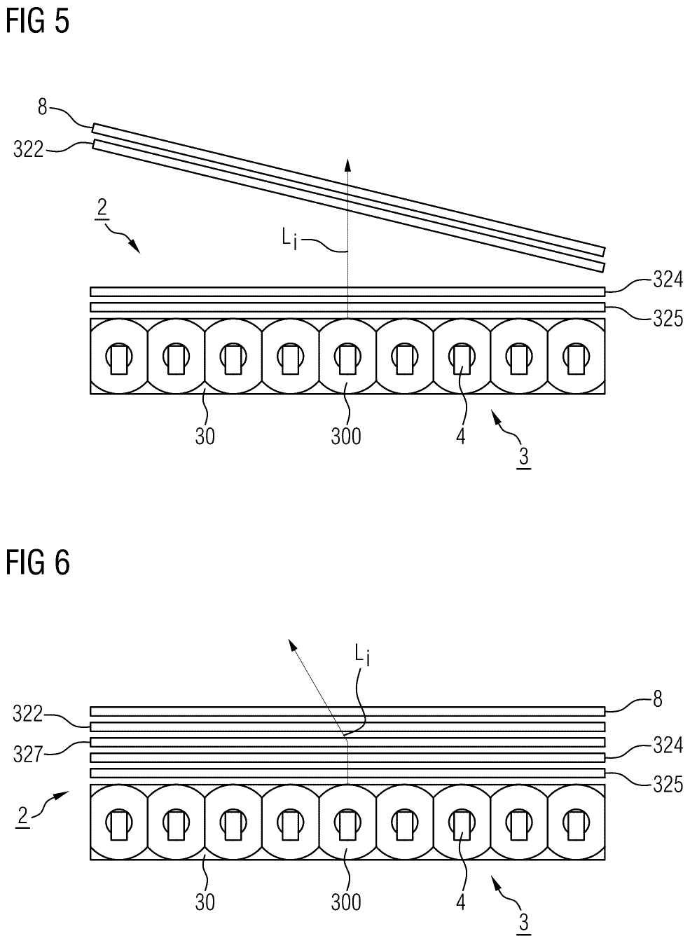

FIG. 6 shows a front view of a backlight unit 2 in accordance with a second embodiment, which uses a light guide 3 according to one aspect of the invention. The embodiment largely corresponds to the embodiment in FIG. 5. In this embodiment, however, the display panel 8 and the diffuser film 322 are arranged parallel to the top side of the light guiding portion of the light guide 3. In this example, an additional prism film 327 is arranged on the reflective polarizer 324 in order to change the direction of the illumination light L₁. The prism film 327 is optional and can likewise be omitted. In this case, the viewing direction is perpendicular to the display panel 8. As before, the various optical layers 322, 324, 325, 327 are illustrated as separate layers. In practice, they can be stacked on the top side of the light guiding portion.

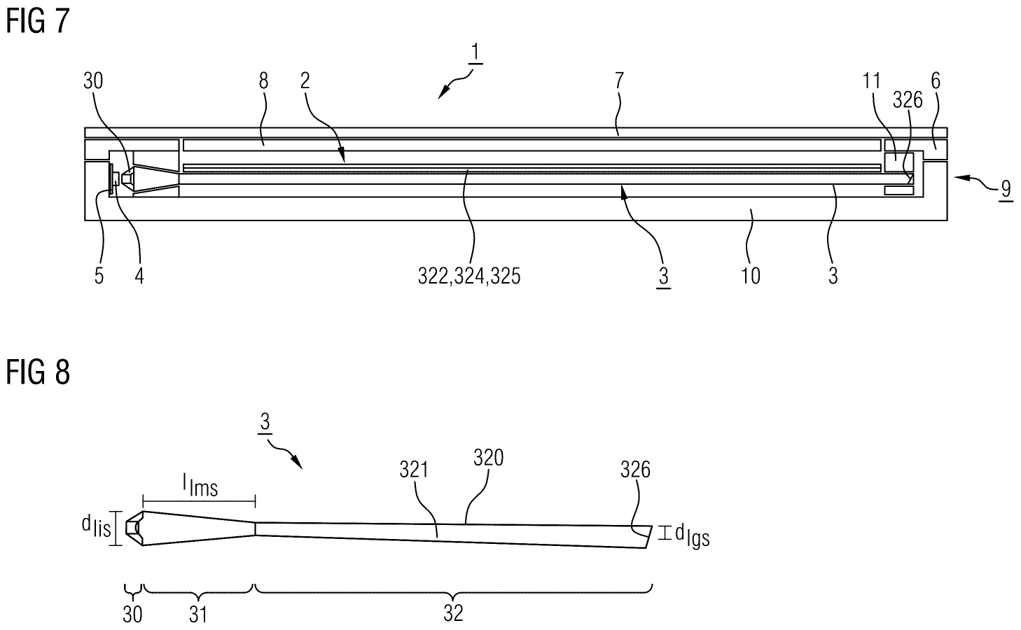

FIG. 7 shows a section through a display device 1 having a backlight unit 2 having a light guide 3 according to one aspect of the invention. The display device 1 comprises a housing 9 having a backplate 10. The housing 9 is sealed by a cover glass 7. In this example, the cover glass 7 is adhesively bonded onto a securing element 6 of the housing 9. A display panel 8 is adhesively bonded to the cover glass 7 and is illuminated by the backlight unit 2. The backlight unit 2 comprises a light guide 3 according to the invention. An arrangement of light sources 4 is mounted on a side wall of the backplate 10. The light sources 4 are mounted on a printed circuit board 5 alongside the light guide 3 such that they emit light in the direction of the light incoupling portion 30 of the light guide 3. For example, the light sources 4 can be front emitting diodes, i.e. light-emitting diodes which emit from their top side. A padded strip 11 is arranged between the securing element 6 of the housing 9 and the light guide 3 in order to prevent a movement of the light guide 3 in a direction perpendicular to the display panel 8. A movement of the light guide 3 in a direction parallel to the display panel 8 can be prevented by projections of the backplate 10, which are not illustrated in FIG. 7.

FIG. 8 shows a side view of the light guide 3, similar to that described in regard to FIG. 2. In contrast thereto, here the top side 320 and the underside 321 are oriented nonparallel to one another. Adjacent to the light mixing portion 31 they have a smaller thickness D_{lgsi} than the thickness D_{lgs} in the region of the end face 326.

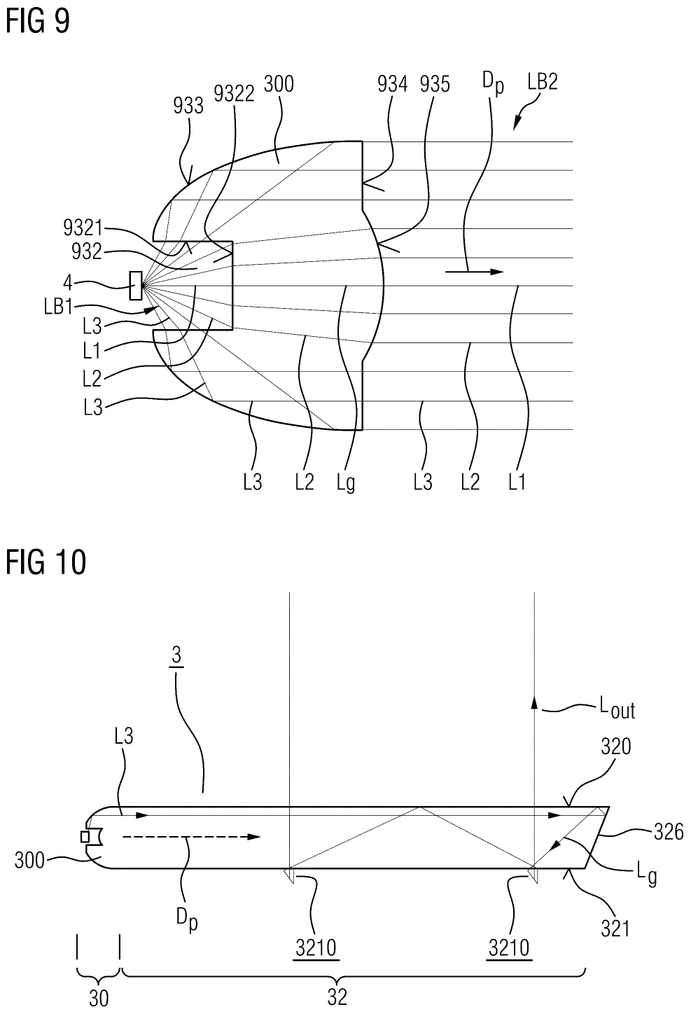

FIG. 9 shows a total internal reflection collimator 300, often also referred to as TIR collimator, in a sectional illustration. Hereinafter, a collimator is referred to as a total internal reflection collimator if it is based at least in part on total internal reflection (total internal reflection at an inner surface). A hybrid collimator having both reflectively coated reflection surfaces and uncoated surfaces at which light rays are reflected by means of total internal reflection is therefore also referred to here as a total internal reflection collimator. The total internal reflection collimator 300 consists of glass, plexiglass, or some other light-transmissive material. A light source 4 is located on its left side. Said light source is located near a recess 932 which is like a blind hole and which is located on the underside of the total internal reflection collimator 300, the light entrance side thereof. In the exemplary embodiment illustrated, said recess has a rectangular cross section with a side face 9321 and a bottom face 9322. A curved surface 933 adjoins the recess 932 radially outwardly. The side of the total internal reflection collimator 300 which faces away from the light source 4 and at which the light exits has a ring-shaped surface 934 in the radially outer region, in the center of which surface a convex surface 935 is located.

The light source 4 generates a widely spread beam LB1. A central light ray L1 leaves the light source 4 in the main direction of propagation D_{P}. It enters the total internal reflection collimator 300 through the bottom face 9322 of the recess 932 without being refracted, passes through it, and exits at the convex surface 935. Since it is located in the central axis of symmetry of the total internal reflection collimator 300, it is not refracted here either. A further light ray L2 travels at an angle with respect to the central axis of symmetry of the total internal reflection collimator 300 and enters the total internal reflection collimator 300 in a marginal region of the bottom face 9322. It is refracted slightly toward the central axis of symmetry. After passing through the total internal reflection collimator 300, it is incident on the inside of the convex surface 935, specifically in its outer region, and is refracted there toward the central axis of symmetry. It leaves the total internal reflection collimator 300 almost parallel to the direction of propagation D_{P}. The radially inner region of the total internal reflection collimator 300 acts with the convex surface 935 in a similar way to a converging lens. A light ray L3, which leaves the light source 4 at an angle that deviates greatly from the main radiation direction, enters the total internal reflection collimator 300 through the side face 9321. When entering, it is refracted and then has an even larger angle with respect to the main radiation direction. It then strikes the inside of the curved surface 933, at which it is subjected to total internal reflection. After the total internal reflection, it already travels parallel to the main radiation direction and leaves the total internal reflection collimator 300 through the ring-shaped surface 934. In the illustration, the face of the ring-shaped surface 934 perpendicular to the main radiation direction is flat; the light ray L3 is not refracted because it is already aligned parallel to the main radiation direction. The total internal reflection at the inside of the curved surface 933 is achieved in the exemplary embodiment by virtue of the fact that the angle does not fall below the corresponding critical angle for the total internal reflection. In accordance with one variant, the curved surface 933 is reflectively coated inwardly, with the result that the total internal reflection is attributable to that reflective coating. In this case it is not necessary to consider the critical angle. A freer design of the shape of the curved surface 933 and possibly of further faces of the total internal reflection collimator 300 is thus made possible. The drawing depicts even further rays, which leave the total internal reflection collimator either through the convex surface 935, like the light rays L1, L2, or through the ring-shaped surface 934, like the light ray L3. The faces 933, 934, 935, 9321, 9322 are furthermore chosen such that a redistribution of the light rays incident in the total internal reflection collimator 300 leads to parallelization with respect to the main radiation direction and also to the fact that the illuminance, i.e. the light power per unit area, after the light rays exit the total internal reflection collimator in the beam LB2 is constant or almost constant over the area. The light beam LB2 leaving the total internal reflection collimator 300 then enters the light guiding portion 32—not illustrated here.

FIG. 10 shows a light guide 3 in which the light incoupling portion 30 principally consists of total internal reflection collimators 300, and merges directly into the light guiding portion 32. The incoupled light thus travels almost parallel to the top side 320 and to the underside 321 of the light guiding portion 32 according to the direction of propagation Dₚ. Light rays that nevertheless impinge on the top side 320 or the underside 321 impinge there at an angle having an absolute value above the total internal reflection angle (also: critical angle, usually defined with respect to the perpendicular to the surface), and are thus guided within the light guiding portion 32 until they are reflected at the inclined end face 326. Light rays that even then—still above the total internal reflection angle—impinge from the inner area on the top side 320 or the underside 321 are reflected by these and are then guided in the light guiding portion 32 in the opposite direction to the direction Dₚ. If guided light L_{g} impinges on an outcoupling structure 3210, it is steered by the latter in the direction of the top side 320 and is outcoupled there as outcoupled light Lₒᵤₜ. Since the outcoupling structures 3210 in some instances do not extend over the full width of the light guiding portion 32, the drawing also shows a portion of the light L_{g} which does not impinge on the outcoupling structure 3210 on the right in the drawing, but rather is reflected from the underside 321, and is reflected in the direction of the top side 320 only by the left outcoupling structure of the two outcoupling structures 3210 shown.

Thus, while there have shown and described and pointed out fundamental novel features of the invention as applied to a preferred aspect thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A light guide for a backlight unit, comprising:
at least one light incoupling portion having at least one arrangement of total internal reflection collimators; and
a light guiding portion, comprising:
a reflective inclined end face;
a top side; and
an underside,
wherein the light guiding portion is configured to guide light coming from the at least one light incoupling portion within the light guiding portion to the reflective inclined end face, and outcouples light reflected by the reflective inclined end face through the top side.

2. The light guide as claimed in claim 1, wherein the at least one light incoupling portion has a first thickness, the light guiding portion has a second thickness, and a conical light mixing portion is present, which connects the at least one light incoupling portion and the light guiding portion.

3. The light guide as claimed in claim 2, wherein the underside of the light guiding portion has outcoupling structures, wherein the outcoupling structures have regions which are inclined relative to the underside of the light guiding portion and configured to steer a fraction of the light guided within the light guiding portion and coming from the reflective inclined end face to the top side of the light guiding portion.

4. The light guide as claimed in claim 3, wherein a length and a taper of the conical light mixing portion and an inclination of the reflective inclined end face are arranged such that in conjunction with the outcoupling structures the light outcoupled from the light guiding portion has a narrow angular distribution.

5. The light guide as claimed in claim 4, wherein a density of the outcoupling structures along a direction of propagation of the light guided within the light guiding portion and reflected by the reflective inclined end face is embodied such that the light outcoupled from the light guiding portion has a substantially constant brightness distribution over an entire length of the light guiding portion.

6. The light guide as claimed in claim 1, further comprising a diffuser film arranged on or above the top side of the light guiding portion.

7. The light guide as claimed in claim 1, further comprising a reflective coating arranged on the underside of the light guiding portion.

8. The light guide as claimed in claim 3, further comprising a reflective polarizer arranged on the top side of the light guiding portion.

9. The light guide as claimed in claim 8, further comprising a retardation layer arranged between the top side of the light guiding portion and the reflective polarizer.

10. The light guide as claimed in claim 8, wherein the light guiding portion consists of a birefringent material.

11. The light guide as claimed in claim 8, wherein the outcoupling structures have regions extending parallel to the underside of the light guiding portion.

12. A backlight unit comprising:
a light guide, comprising:
at least one light incoupling portion having at least one arrangement of total internal reflection collimators;
a light guiding portion, comprising:
a reflective inclined end face;
a top side; and
an underside,
wherein the light guiding portion is configured to guide light coming from the at least one light incoupling portion within the light guiding portion to the reflective inclined end face, and outcouples light reflected by the reflective inclined end face through the top side; and
at least one arrangement of light sources configured to emit light in a direction of the total internal reflection collimators.

13. A display device comprising:
a backlight unit;
a light guide, comprising:
at least one light incoupling portion having at least one arrangement of total internal reflection collimators; and
a light guiding portion, comprising:
a reflective inclined end face;
a top side; and
an underside,
wherein the light guiding portion is configured to guide light coming from the at least one light incoupling portion within the light guiding portion to the reflective inclined end face, and outcouples light reflected by the reflective inclined end face through the top side;
at least one arrangement of light sources configured to emit light in a direction of the total internal reflection collimators; and
a display panel configured such that it is illuminated by light provided by the backlight unit.

14. The display device as claimed in claim 13, wherein the display device is configured for a head-up display or to provide a switchable data protection functionality.

15. The display device as claimed in claim 13, further comprising a prism film configured to change a direction of the light coming from the backlight unit.
